(19) United States
(12) Patent Application Publication
(10) Pub. No.: US 2026/0038024 A1
(43) Pub. Date: Feb. 5, 2026

(54) METHOD FOR DISPLAYING CONTENT, APPARATUS, DEVICE, COMPUTER-READABLE STORAGE MEDIUM AND PRODUCT

(71) Applicant: DOUYIN VISION CO., LTD., Beijing (CN)

(72) Inventors: Chuanqi Jing, Beijing (CN); Jinghua Li, Beijing (CN)

(21) Appl. No.: 19/050,417

(22) Filed: Feb. 11, 2025

(30) Foreign Application Priority Data
Jul. 30, 2024 (CN) 202411037923.4

(51) Int. Cl. G06Q 30/0601

(52) U.S. Cl. CPC G06Q 30/0631; G06Q 30/0641

(57) ABSTRACT

Embodiments of the present disclosure provide a method for displaying content and apparatus, a device, a computer-readable storage medium, and a product. The method includes: displaying at least one piece of recommended content for recommending media content, wherein a publisher of the recommended content is associated with at least one content consumption feature label, the content consumption feature label is generated based on historical consumption data of the publisher for the media content, and wherein the content consumption feature label corresponds to different content consumption feature dimensions; determining at least one target content consumption feature label in at least one target content consumption feature dimension based on associated data corresponding to the recommended content; and displaying the at least one target content consumption feature label in the recommended content.

### CROSS-REFERENCE TO RELATED APPLICATION(S)

This application claims priority to Chinese Application No. 202411037923.4 filed Jul. 30, 2024, the disclosure of which is incorporated herein by reference in its entity.

### TECHNICAL FIELD

Embodiments of the present disclosure relate to the technical field of data processing, and in particular, to a method for displaying content, an apparatus, a device, a computer-readable storage medium and a product.

### BACKGROUND

With the improvement of hardware performance of terminal devices, more and more applications (Application, APP for short) are running on the terminal devices. For example, a first user may read and listen to a book based on a preset book application, or the first user may browse a video in a video application. When using an application to browse content, the first user often needs to discover more media content for browsing that has not been browsed currently.

In the related art, in order to facilitate the first user to discover media content, interactive content with a preset theme may be published in the application. A second user may recommend desired media content in the interactive content with the preset theme.

However, the second user who publishes the recommended content may have a different media content consumption type from the first user, and thus the media content recommended by the second user may not meet the needs of the first user. As a result, the first user cannot quickly and accurately discover the media content.

### SUMMARY

Embodiments of the present disclosure provide a method for displaying content, an apparatus, a device, a computer-readable storage medium and a product, so as to solve the technical problem that a user cannot accurately and quickly discover media content based on recommended content published by a publisher.

In a first aspect, an embodiment of the present disclosure provides a method for displaying content, including: displaying at least one piece of recommended content for recommending media content, wherein a publisher of the recommended content is associated with at least one piece of content consumption feature label, the content consumption feature label is generated based on historical consumption data of the publisher for the media content, and wherein the content consumption feature label corresponds to different content consumption feature dimensions; determining at least one target content consumption feature label in at least one target content consumption feature dimension based on associated data corresponding to the recommended content; and displaying the at least one target content consumption feature label in the recommended content.

In a second aspect, an embodiment of the present disclosure provides a method for displaying content, including: acquiring recommended content to be published, the recommended content to be published including at least one piece of media content to be recommended and recommendation data generated based on the at least one piece of media content to be recommended; determining at least one content consumption feature label associated with a user, wherein the content consumption feature label is generated based on historical consumption data of the user for media content; determining at least one target content consumption feature label in at least one target content consumption feature dimension based on the recommended content and a publishing scene associated with the recommended content; and publishing the recommended content, wherein the at least one target content consumption feature label is carried in the recommended content.

In a third aspect, an embodiment of the present disclosure provides an apparatus of displaying content, including: a display module, configured to display at least one piece of recommended content for recommending media content, wherein a publisher of the recommended content is associated with at least one piece of content consumption feature label, the content consumption feature label is generated based on historical consumption data of the publisher for the media content, and wherein the content consumption feature label corresponds to different content consumption feature dimensions; a determination module, configured to determine at least one target content consumption feature label in at least one target content consumption feature dimension based on associated data corresponding to the recommended content; and a processing module, configured to display the at least one target content consumption feature label in the recommended content.

In a fourth aspect, an embodiment of the present disclosure provides an apparatus for displaying content, including: an acquisition module, configured to acquire recommended content to be published, the recommended content to be published including at least one piece of media content to be recommended and recommendation data generated based on the at least one piece of media content to be recommended; a generation module, configured to determine at least one piece of content consumption feature label associated with a user, wherein the content consumption feature label is generated based on historical consumption data of the user for media content; a selection module, configured to determine at least one target content consumption feature label in at least one target content consumption feature dimension based on the recommended content and a publishing scene associated with the recommended content; and a publishing module, configured to publish the recommended content, wherein the at least one target content consumption feature label is carried in the recommended content.

In a fifth aspect, an embodiment of the present disclosure provides an electronic device, including: a processor and a memory; the memory stores computer-executable instructions; and the processor executes the computer-executable instructions stored in the memory, to enable the at least one processor to execute the method for displaying content according to the first aspect and various possible designs thereof or the second aspect and various possible designs thereof.

In a sixth aspect, an embodiment of the present disclosure provides a computer-readable storage medium, the computer-readable storage medium stores computer-executable instructions, and when a processor executes the computer-executable instructions, the method for displaying content according to the first aspect and various possible designs thereof or the second aspect and various possible designs thereof is implemented.

In a seventh aspect, an embodiment of the present disclosure provides a computer program product, including a computer program, and when the computer program is executed by a processor, the method for displaying content d according to the first aspect and various possible designs thereof or the second aspect and various possible designs thereof is implemented.

According to the method for displaying content, the apparatus, the device, the computer-readable storage medium and the product provided in the embodiments, when displaying the recommended content for recommending the media content, the at least one target content consumption feature label in the at least one target content consumption feature dimension is determined based on associated data corresponding to the recommended content, and the at least one target content consumption feature label is displayed in the recommended content, so that the personalized label associated with the publisher and the recommendation scene may be displayed in the recommended content. The user can locate the publisher with the same or similar consumption behavior more accurately through the target content consumption feature label, and view the media content recommended by the publisher, thereby the efficiency and accuracy of media content discovery can be improved.

### BRIEF DESCRIPTION OF THE DRAWINGS

In order to illustrate the technical solutions according to embodiments of the present disclosure or in the prior art clearer, brief description will be made below for the drawings for describing the embodiments or the prior art. Obviously, the drawings in the following description are some embodiments of the present disclosure, and for those of ordinary skilled in the art, other drawings may be obtained from these drawings without creative effort.

FIG. 1 is a schematic flowchart of a method for displaying content provided according to an embodiment of the present disclosure;

FIG. 2 is a schematic diagram of a display interface provided according to an embodiment of the present disclosure;

FIG. 3 is a schematic flowchart of a method for displaying content provided according to another embodiment of the present disclosure;

FIG. 4 is a schematic flowchart of a method for displaying content provided according to another embodiment of the present disclosure;

FIG. 5 is a schematic flowchart of a method for displaying content provided according to another embodiment of the present disclosure;

FIG. 6 is a schematic flowchart of a method for displaying content provided according to another embodiment of the present disclosure;

FIG. 7 is a schematic flowchart of a method for displaying content provided according to an embodiment of the present disclosure;

FIG. 8 is a schematic structural diagram of an apparatus for displaying content provided according to an embodiment of the present disclosure;

FIG. 9 is a schematic structural diagram of an apparatus for displaying content provided according to an embodiment of the present disclosure; and

FIG. 10 is a schematic structural diagram of an electronic device provided by an embodiment of the present disclosure.

### DETAILED DESCRIPTION OF EMBODIMENTS

In order to make the objectives, technical solutions and advantages of the embodiments of the present disclosure clearer, technical solutions according to embodiments of the present disclosure will be described clearly and comprehensively below with reference to the drawings according to embodiments of the present disclosure. Obviously, the described embodiments are merely a part of the embodiments of the present disclosure, rather than all the embodiments. Based on the embodiments in the present disclosure, all other embodiments obtained by a person of ordinary skilled in the art without creative effort shall fall within the protection scope of the present disclosure.

It may be understood that, before using the technical solutions disclosed according to embodiments of the present disclosure, a user should be informed of the type, scope of use, usage scenario, etc. of the personal information involved in the present disclosure in an appropriate manner according to relevant laws and regulations, and the user's authorization should be obtained.

For example, in response to receiving an active request from the user, prompt information is sent to the user to explicitly prompt the user that the operation requested to be performed will require acquisition and use of the user's personal information. Thus, the user may select, according to the prompt information, whether to provide personal information to software or hardware such as an electronic device, an application, a server or a storage medium that performs operation of the technical solution of the present disclosure.

As an optional but non-limiting implementation, a manner of sending the prompt information to the user in response to receiving the active request from the user may be, for example, a pop-up window, and the prompt information may be presented in a form of text in the pop-up window. In addition, the pop-up window may further carry a selection control for the user to select “agree” or “disagree” to provide personal information to the electronic device.

It may be understood that the above process of notifying and obtaining the user's authorization is only schematic, and does not constitute a limitation on the implementation of the present disclosure. Another manner that satisfies relevant laws and regulations may also be applied to the implementation of the present disclosure.

In order to solve the technical problem that a user cannot accurately and quickly discover media content based on recommended content published by a publisher, the present disclosure provides a method for displaying content, an apparatus, a device, a computer-readable storage medium and a product.

It should be noted that the method for displaying content, the apparatus, the device, the computer-readable storage medium and the product provided by the present disclosure may be applied to any content recommendation scenario.

In order to facilitate communication between users and to discovery more media content, the publisher may perform an operation of publishing recommended content in a target application. Taking a book application as an example, the user may publish a topic of “recommendation wanted” for a certain type of books according to actual needs. When browsing such a topic, the publisher may recommend a book matching a preset theme under the topic. In addition, the user may also browse the recommended content published by the publisher under the topic.

However, different users have different browsing preferences and browsing styles for media content. Therefore, the user cannot quickly and accurately locate the desired media content based on the recommended content published by the publisher.

In the process of solving the above technical problems, inventors of the present disclosure find through research that, in order to enable the user to more intuitively understand the personalized consumption habits of the publisher who publishes the media content recommendation, at least one target content consumption feature label associated with the user may be displayed in a display region associated with the user. For example, it may be displayed that the publisher is a fan of a certain type of books, or that the publisher has read or recommended the same book as the current user, etc.

Optionally, in order to accurately determine the personalized consumption habits of the publisher, historical consumption data of each publisher for the media content in the target application may be determined, and the content consumption feature label associated with the publisher may be determined based on the historical consumption data.

Further, there may be multiple publisher associated content consumption feature labels. The multiple content consumption feature labels may correspond to different content consumption feature dimensions. In order to enable the content consumption feature label displayed in the recommended content to be more in line with the current recommendation scene, at least one target content consumption feature label in at least one target content consumption feature dimension may be determined based on the associated data corresponding to the recommended content. At least one target content consumption feature label may be displayed in the recommended content.

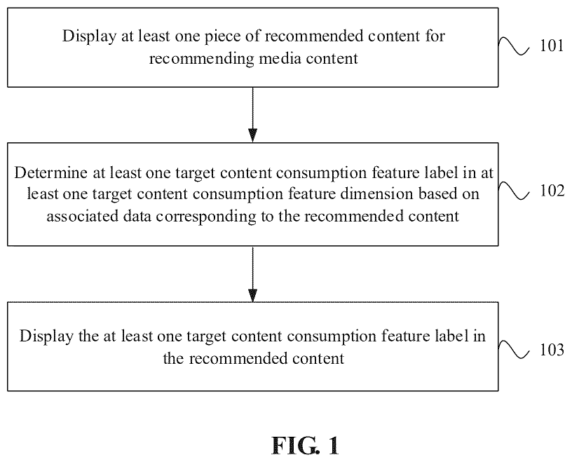

FIG. 1 is a schematic flowchart of a method for displaying content provided according to an embodiment of the present disclosure. As shown in FIG. 1, the method includes following steps.

Step 101: displaying at least one piece of recommended content for recommending media content. A publisher of the recommended content is associated with at least one content consumption feature label, and the content consumption feature label is generated based on historical consumption data of the publisher for the media content. The content consumption feature label corresponds to different content consumption feature dimensions.

An execution body of this embodiment is an apparatus for displaying content. The apparatus for displaying content may be coupled to a terminal device, so that at least one target content consumption feature label associated with a publisher of the recommended content may be determined and displayed based on a trigger operation of a user on the terminal device. Alternatively, the apparatus for displaying content may also be coupled to a server in communication connection with the terminal device, so that at least one target content consumption feature label associated with the publisher of the recommended content may be determined and displayed based on the trigger operation of the user on the terminal device, and the terminal device may be controlled to display the recommended content.

In this implementation, a user may browse media content in the target application. For example, the user may read and listen to a book in a book application. Alternatively, the user may watch a video in a video application.

In the process of browsing media content, in order to facilitate the user to discover richer and high-quality media content, interactive content may also be published in the target application. For example, an interactive topic for finding a specific type of book may be published in the book application. Alternatively, a topic for recommending a book may be published in the book application. The interactive content with the preset theme may be published by the user, or may be published by another publisher. Alternatively, the interactive content may also be published by an official of the target application, which is not limited by the present disclosure.

After the interactive content is published, the user may publish recommended content in the interactive content. Alternatively, the user may view the interactive content according to actual needs.

Optionally, the interactive content may correspond to an associated control. In response to a user's trigger operation on the associated control of the preset theme in the target application, at least one piece of recommended content for recommending media content may be displayed. A publisher of the recommended content is associated with at least one content consumption feature label, and the content consumption feature label is generated based on historical consumption data of the publisher for the media content. The content consumption feature label corresponds to different content consumption feature dimensions.

For example, the content consumption feature label may be “She/He has also recommended book A”, “She/He has also been reading XX recently”, “She/He also likes reading XX articles”, “She/He also liked XX,” etc.

The content consumption feature label corresponds to different content consumption feature dimensions. The content consumption feature dimension includes, but is not limited to, an author dimension associated with the media content, a recommended media content type dimension, a browsing age limit dimension for the media content, etc. Taking the content consumption feature dimension as the book media content type dimension for an example, the content consumption feature dimension may correspond to content consumption feature labels such as a novice literature fan, an intermediate and advanced literature fan, a strategy literature fan, a romance literature fan, etc.

Alternatively, the media content includes, but is not limited to, book media content, video media content, audio media content, etc., which is not limited by the present disclosure.

For example, an interactive topic for finding a specific type of a book may be pre-published in the book application. The publisher may publish recommended content in the interactive content, and the recommended content may include a recommended book selected by the publisher according to actual conditions, and may include recommendation data for the recommended book. The recommendation data includes, but is not limited to, a recommendation text, a recommendation image, etc. In order to enable the user to view the publisher of the recommended content more intuitively, the recommended content may further include identification information of the publisher.

Step 102: determining at least one target content consumption feature label in at least one target content consumption feature dimension based on associated data corresponding to the recommended content.

In this implementation, in the process of browsing the at least one piece of recommended content by the user, in order to enable the user to discover the desired media content more quickly and accurately, the content consumption feature label associated with the publisher may be displayed in the recommended content. Thus, when browsing the recommended content, the user may have an initial impression about a browsing style of the publisher based on the content consumption feature label, and then the user may discover the media content more specifically based on the browsing style.

Alternatively, since the publisher is associated with at least one content consumption feature label, in order to enable the target content consumption feature label displayed in the current recommended content to be more in line with the current recommendation scene, at least one target content consumption feature label that matches the current recommendation scene more may be determined from the at least one content consumption feature label.

Further, in order to implement a selection operation on the content consumption feature label, the associated data corresponding to the recommended content may be acquired. The associated data may include, but is not limited to, at least one associated piece of media content in the recommended content, a recommendation text/a recommendation image associated with the recommended content, topic content associated with the recommended content, etc.

After acquiring the associated data corresponding to the at least one piece of recommended content, the at least one target content consumption feature label that matches the current recommendation scene more may be determined among the at least one piece of content consumption feature label based on the associated data.

As an implementation that may be implemented, the content consumption feature label corresponds to different content consumption feature dimensions. The target content consumption feature dimension may be determined based on the associated data, and the at least one target content consumption feature label may be further determined, based on the associated data, among the at least one piece of content consumption feature label associated with the target content consumption feature dimension.

Step 103: displaying the at least one target content consumption feature label in the recommended content.

In this implementation, after determining the at least one target content consumption feature label corresponding to the publisher, the at least one target content consumption feature label may be displayed in the recommended content.

For example, in order to avoid at least one target content consumption feature label from blocking another piece of recommended content, the target content consumption feature label may be displayed behind the publisher identification, or the target content consumption feature label may be displayed below the publisher identification. The display size of the target content consumption feature label may be smaller than a display size of another piece of content in the recommended content.

As an implementation that may be implemented, the user may adjust a display parameter of the target content consumption feature label according to actual needs. The display parameter includes, but is not limited to, a display position, a display size, a display color, etc.

Therefore, when browsing the recommended content in the content display page, the user may view the media content recommended by the publisher who publishes the recommended content in a targeted manner based on the at least one target content consumption feature label of the publisher.

For example, a target content consumption feature label associated with the publisher A is “She/He has also recommended book A,” which characterizes that the publisher and the user have recommended the same book A historically. Therefore, the publisher and the user may have a similar browsing preference for books. The books recommended by the publisher may be more in line with the personalized needs of the user.

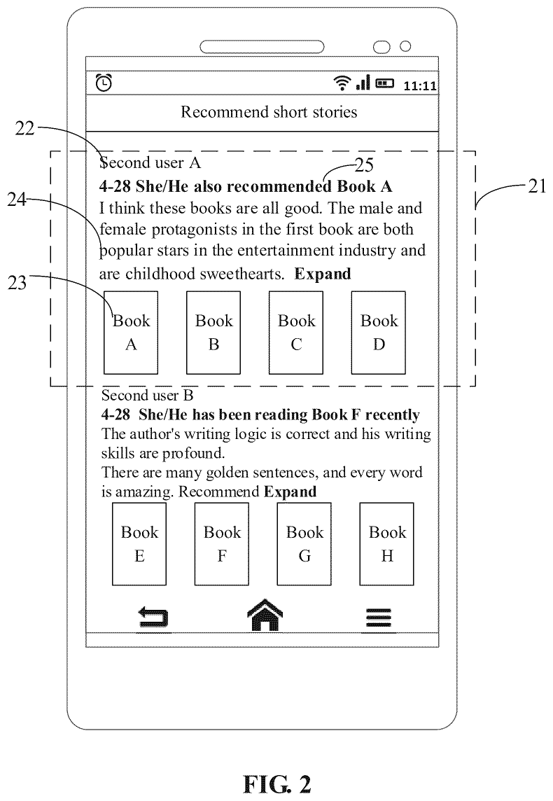

FIG. 2 is a schematic diagram of a display interface provided according to an embodiment of the present disclosure. As shown in FIG. 2, at least one piece of recommended content 21 may be displayed in the display interface, in which the recommended content 21 may include identification information 22 of a publisher, at least one piece of media content to be recommended 23 and recommendation data 24. The recommendation data 24 may be a recommendation text. At least one target content consumption feature label 25 is displayed in a display region associated with the publisher in the recommended content 21.

According to the method for displaying content provided in this embodiment, when displaying the recommended content for recommending the media content, at least one target content consumption feature label in at least one target content consumption feature dimension is determined based on associated data corresponding to the recommended content, and at least one target content consumption feature label is displayed in the recommended content, so that the personalized label associated with the publisher and the recommendation scene may be displayed in the recommended content. The user may locate the publisher with the same or similar consumption behavior more accurately through the target content consumption feature label, and view the media content recommended by the publisher. Thereby, the efficiency and accuracy of media content discovery can be improved.

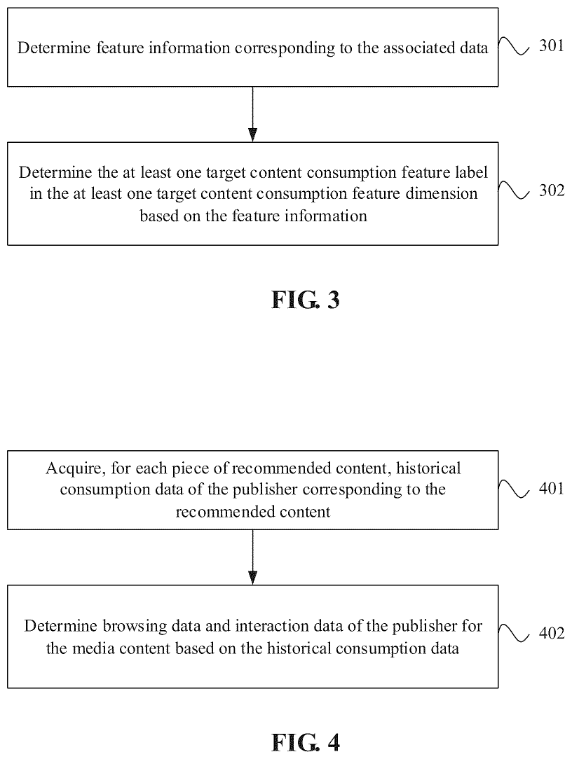

FIG. 3 is a schematic flowchart of a method for displaying content provided according to another embodiment of the present disclosure. Based on any of the above embodiments, as shown in FIG. 3, step 102 includes the following steps.

Step 301: determining feature information corresponding to the associated data.

Step 302: determining at least one target content consumption feature label in at least one target content consumption feature dimension based on the feature information.

According to this embodiment, in order to accurately determine the at least one target content consumption feature label based on the associated data, feature information corresponding to the associated data may be determined first. The feature information corresponding to the associated data may be determined by using any manner capable of implementing feature extraction, which is not limited by the present disclosure. For example, the feature extraction operation on the associated data may be implemented by using a preset feature extraction algorithm. Alternatively, a keyword extraction operation may be performed on the associated information, and the keyword is determined as the feature information.

Furthermore, after determining the feature information corresponding to the associated data, the at least one target content consumption feature label in the at least one target content consumption feature dimension may be determined based on the feature information. For example, determination of the target content consumption feature label may be implemented by calculating a similarity between the feature information and the content consumption feature label. Alternatively, determination of the target content consumption feature label may be implemented by calculating a vector distance between the feature information and the content consumption feature label, which is not limited by the present disclosure.

According to the method for displaying content provided in this embodiment, the feature information corresponding to the associated data is determined, and then the at least one target content consumption feature label matching the feature information may be determined accurately from the at least one content consumption feature label based on the feature information, so that the target content consumption feature label displayed in the recommended content is more in line with the current recommendation scene.

Alternatively, based on any of the above embodiments, the associated data may include at least one piece of media content to be recommended that is corresponding to the recommended content. Step 301 may include: acquiring first parameter information associated with the at least one piece of media content, and the first parameter information may include basic information and historical interaction information corresponding to the at least one piece of media content; and determining feature information associated with the at least one piece of media content based on the first parameter information, and the feature information may include category information, creator information and content type information that correspond to the at least one piece of media content.

In this embodiment, the associated data includes at least one piece of media content to be recommended that is corresponding to the recommended content. Taking the media content as the book media content for an example, the recommended content may include at least one piece of book media content determined by the publisher. In order to enable the target content consumption feature label to be more in line with the currently published recommended content, the feature information may be determined based on the at least one piece of media content to be recommended.

Alternatively, the first parameter information associated with the at least one piece of media content may be acquired, and the first parameter information may include basic information and historical interaction information corresponding to the at least one piece of media content. Continuing with the above example, when the media content is the book media content, the first parameter information may include, but is not limited to, a name of the book, author information of the book, an introduction of the book, a category to which the book belongs, a comment published by a reader based on the book media content, a markup of a sentence in the book media content by the reader, a published note, etc., which is not limited by the present disclosure.

Further, feature information associated with the at least one piece of media content may be determined based on the first parameter information, and the feature information may include category information, creator information and content type information that correspond to the at least one piece of media content. For example, the author information of the book media content, the category to which the book belongs, the writing style type of the book, etc. may be extracted based on the first parameter information to obtain the feature information.

According to the method for displaying content provided in this embodiment, a feature extraction operation is performed based on the at least one piece of media content to be recommended that is corresponding to the recommended content, so that the determined at least one target content consumption feature label may be more in line with the at least one piece of media content to be recommended currently, and then the user may discover and browse the media content based on the at least one target content consumption feature label more accurately.

Alternatively, based on any of the above embodiments, the associated data may include recommendation data in the recommended content, and the recommendation data may include a recommendation text and/or a recommendation image. Step 301 may include: identifying a text keyword in the recommendation text, and/or identifying an image feature corresponding to the recommendation image.

The text keyword and/or the image content is determined as the feature information.

In this embodiment, the associated data may be the recommendation data in the recommended content, and the recommendation data may include the recommendation text and/or the recommendation image. Taking the media content as the book media content for an example, the recommended content may include the recommendation text and/or the recommendation image generated by the publisher based on the at least one piece of book media content to be recommended.

Alternatively, the text keyword in the recommendation text may be identified, and/or the image feature corresponding to the recommendation image may be identified. The keyword identification operation may be performed on the recommendation text by using any manner capable of implementing keyword identification. A feature extraction operation may be performed on the recommendation image by using any manner capable of implementing image feature extraction, which is not limited by the present disclosure. The text keyword and/or the image content is determined as the feature information.

According to the method for displaying content provided in this embodiment, the feature extraction operation is performed based on the recommendation data corresponding to the recommended content, so that the determined at least one target content consumption feature label may be more in line with the recommendation data generated by the publisher, and may better reflect the personalized information corresponding to the recommended content. Thus, the user may discover and browse the media content based on the at least one target content consumption feature label more accurately.

Alternatively, based on any of the above embodiments, the associated data may include a target interactive topic associated with the at least one piece of recommended content. Step 301 may include: determining at least one keyword associated with the recommended content in the target interactive topic; and determining the at least one keyword as the feature information.

In this embodiment, the associated data may include the target interactive topic associated with the at least one piece of recommended content.

Alternatively, in the process of browsing media content, in order to facilitate the user to discover richer and high-quality media content, interactive content may also be published in the target application. For example, an interactive topic for finding a specific type of book may be published in the book application. The recommended content may be associated with a target interactive topic. For example, the target interactive topic may be “recommendation wanted for strategy literature,” “recommending several palace fighting and courtyard fighting books that I like,” “recommending a book list with a score of 9.9,” etc. The target interactive topic may include keywords associated with the recommended content, such as strategy literature, palace fighting and courtyard fighting, 9.9 points, etc.

Furthermore, at least one keyword associated with the recommended content in the target interactive topic may be determined. The keyword identification operation may be performed on the target interactive topic by using any manner capable of implementing keyword identification. The at least one keyword is determined as the feature information.

According to the method for displaying content provided in this embodiment, the feature extraction operation is performed based on the target interactive topic associated with the at least one piece of recommended content, so that the determined at least one target content consumption feature label may be in line with the current content recommendation scene, and the relevance between the at least one target content consumption feature label and the interactive topic may be improved. Thus, the user may browse the recommended content that is more in line with actual needs under the target interactive topic based on the at least one target content consumption feature label.

Furthermore, based on any of the above embodiments, step 302 may include: determining, for each content consumption feature label, similarity information between the content consumption feature label and the feature information; and determining at least one content consumption feature label with similarity information satisfying a preset condition as the at least one target content consumption feature label.

In this embodiment, after determining the feature information corresponding to the associated data, the at least one target content consumption feature label may be determined from the at least one content consumption feature label associated with the feature information.

Alternatively, the determination of the target content consumption feature label may be implemented based on a similarity between the feature information and the content consumption feature label. For each content consumption feature label, the similarity information between the content consumption feature label and the feature information is determined. The similarity information between the content consumption feature label and the feature information may be calculated by using any manner capable of implementing similarity calculation. For example, a text similarity may be calculated, or the content consumption feature label and the feature information may be vectorized respectively, and then the similarity calculation may be implemented based on the distance between vectors, which is not limited by the present disclosure.

Furthermore, at least one content consumption feature label with similarity information satisfying the preset condition may be determined as the at least one target content consumption feature label. For example, the content consumption feature label with the highest similarity may be determined as the target content consumption feature label. Alternatively, at least one content consumption feature label with similarity being greater than a preset threshold may be determined as the at least one target content consumption feature label. Alternatively, the user may also set the preset condition according to actual needs, which is not limited by the present disclosure.

According to the method for displaying content provided in this embodiment, the similarity information between the content consumption feature label and the feature information is determined, so that the at least one target content consumption feature label that is more in line with the current recommendation scene may be accurately determined based on the similarity information, and the efficiency and accuracy of determining the at least one target content consumption feature label can be improved.

Furthermore, based on any of the above embodiments, step 302 may include: determining, from a plurality of content consumption feature dimensions, a target content consumption feature dimension matching at least partial feature information based on the at least partial feature information; and determining, from the at least one content consumption feature label corresponding to the target content consumption feature dimension, at least one target content consumption feature label matching remaining feature information based on the remaining feature information.

In this embodiment, different content consumption feature labels correspond to different content consumption feature dimensions. Therefore, after determining the feature information, the content consumption feature dimension may be determined based on partial feature information first, and then the at least one target content consumption feature label may be determined, from the at least one content consumption feature label corresponding to the content consumption feature dimension, based on the remaining feature information.

Alternatively, the target content consumption feature dimension matching the at least partial feature information may be determined from the plurality of content consumption feature dimensions based on the at least partial feature information. The at least one target content consumption feature label matching the remaining feature information may be determined, from the at least one content consumption feature label corresponding to the target content consumption feature dimension, based on the remaining feature information.

In some embodiments, the user may adjust the at least partial feature information used for selecting the target content consumption feature dimension and the remaining feature information used for selecting the at least one target content consumption feature label according to actual needs, which is not limited by the present disclosure.

Taking the media content to be recommended as the book media content for an example, the content consumption feature dimension selection may be performed based on the feature information of the target topic content associated with the recommended content. The target topic content may be to seek sharing of different types of books. Therefore, the target content consumption feature dimension may be determined as the literature type preference dimension based on the feature information. Furthermore, the at least one target content consumption feature label may be determined, from the at least one content consumption feature label corresponding to the literature type preference dimension, based on the feature information corresponding to at least one piece of book content recommended currently. For example, the target content consumption feature label may be “She/He also likes to read strategy literature,” “She/He is also a novice literature lover,” etc.

According to the method for displaying content provided in this embodiment, at least one content consumption feature dimension may be preset, so that the preliminary selection operation may be performed on the content consumption feature label based on the content consumption feature dimension first. Then at least one target content consumption feature label may be determined from the at least one content consumption feature label corresponding to the target content consumption feature dimension. The accuracy of determining the target content consumption feature label can be improved.

Alternatively, based on any of the above embodiments, step 101 may include: displaying at least one piece of interactive topic content in a preset interactive page; displaying a content display page associated with the interactive topic content in response to a trigger operation of the user on any piece of the interactive topic content; and displaying at least one piece of recommended content related to the interactive topic content in the content display page.

In this embodiment, the target application may include a preset interactive page. A user and a publisher may perform an interactive operation in the interactive page. For example, the user and/or the publisher may publish interactive topic content in the interactive page. The interactive topic content may include, but is not limited to, recommending a certain type of media content, seeking recommendation of a certain type of media content, commenting on content published for a certain piece of media content, etc. At least one piece of interactive topic content may be displayed in the interactive page.

Furthermore, the user may perform a trigger operation on any piece of the interactive topic content in the interactive page. In response to the trigger operation, a content display page associated with the interactive topic may be displayed. Thus, at least one piece of recommended content associated with the interactive topic may be displayed in the content display page, so that the user may view the recommended content in the content display page.

Alternatively, based on any of the above embodiments, step 101 may include: displaying at least one piece of interactive topic content historically published by the user in a preset information page; in response to a trigger operation of the user on any piece of the interactive topic content, displaying a content display page associated with the interactive topic content; and displaying the at least one piece of recommended content related to the interactive topic content in the content display page.

In this embodiment, the user may publish the interactive topic content according to actual needs, and the user or the publisher may publish the recommended content in the interactive topic content. After the interactive topic content is published, the user may also view the interactive topic content in the information page.

Alternatively, the at least one piece of interactive topic content historically published by the user may be displayed in the preset information page. In response to the trigger operation of the user on any piece of the interactive topic content, the content display page associated with the interactive topic content may be displayed. The at least one piece of recommended content related to the interactive topic content is displayed in the content display page.

Alternatively, based on any of the above embodiments, step 101 may include: displaying a preset content recommendation list, and the content recommendation list may include at least one recommendation topic; in response to a trigger operation of the user on any recommendation topic, displaying a content display page associated with the recommendation topic; and displaying the at least one piece of recommended content related to the recommendation topic in the content display page.

In this embodiment, the content recommendation list may be preset, and the content recommendation list may include at least one recommendation topic. The user may view the content recommendation list through a preset trigger operation.

Alternatively, the preset content recommendation list may be displayed, and the content recommendation list may include at least one recommendation topic, and the user and/or the publisher may publish the recommended content according to actual needs under each recommendation topic. When browsing the content recommendation list, the user may view the recommendation topic according to actual needs. In response to a trigger operation of the user on any recommendation topic, the content display page associated with the recommendation topic is displayed. The at least one piece of recommended content related to the recommendation topic is displayed in the content display page.

According to the method for displaying content provided in this embodiment, the topic content is displayed in at least one of the preset interactive page, the preset information page and the preset content recommendation list, so that the user can browse the at least one piece of recommended content more flexibly.

FIG. 4 is a schematic flowchart of a method for displaying content provided by another embodiment of the present disclosure. Based on any of the above embodiments, as shown in FIG. 4, after step 101, the method further includes the following step.

Step 401: acquiring, for each piece of recommended content, historical consumption data of a publisher corresponding to the recommended content.

Step 402: determining browsing data and interaction data of the publisher for the media content based on the historical consumption data, the browsing data at least including a browsing duration for each piece of media content, the interaction data including comment content and/or recommended content published by the publisher for the media content.

Step 403: determining at least one piece of content consumption feature label associated with the publisher according to the browsing data and/or the interaction data.

In this embodiment, in order to implement determination of the content consumption feature label associated with the publisher, historical consumption data of the publisher corresponding to each piece of recommended content may be acquired first. The historical consumption data may include, but is not limited to, the browsing duration of the publisher for the media content, a published comment, published recommended content, etc.

After acquiring the historical consumption data associated with the publisher, the browsing data and the interaction data of the publisher for plurality of pieces of media content may be determined based on the historical consumption data. The browsing data may include at least the browsing duration corresponding to each piece of media content. The interaction data may include the comment content and/or the recommended content published by the publisher for the media content. Thus, the browsing preferences of the publisher for different pieces of media content may be determined based on the browsing data and the interaction data, and the browsing preferences of the publisher for different categories of media content may be determined, etc.

Furthermore, after determining the browsing data and the interaction data corresponding to the publisher respectively, the content consumption feature label associated with the publisher may be determined based on the browsing data and/or the interaction data.

As an implementation that may be implemented, the browsing preferences of the publisher for different pieces of media content may be determined based on the browsing data, to determine the content consumption feature label associated with the publisher. Alternatively, a same or similar browsing behavior between the publisher and the user who currently browses the recommended content may be determined based on the browsing data and the behavior data, and the content consumption feature label associated with the publisher may be determined based on the browsing behavior. This is not limited by the present disclosure.

According to the method for displaying content provided in this embodiment, the historical consumption data of the publisher corresponding to the recommended content is acquired, the browsing data and the interaction data of the publisher for the media content are determined based on the historical consumption data, and then the at least one content consumption feature label associated with the publisher may be determined according to the browsing data and/or the interaction data. The content consumption feature label may accurately characterize the browsing characteristics of the publisher for the media content. Then after displaying the content consumption feature label, the user may view the recommended content published by the publisher in a targeted manner based on the content consumption feature label.

Furthermore, based on any of the above embodiments, step 403 may include: acquiring associated consumption data of the user for the media content, wherein the user is a user who performs the browsing operation on the at least one piece of recommended content; determining a related browsing behavior between the user and the publisher based on the associated consumption data and the browsing data and/or the interaction data; and determining at least one piece of content consumption feature label associated with the publisher based on the related browsing behavior.

In this embodiment, the user may have browsed the same media content with the publisher historically, or the user and the publisher may both prefer the same type of media content. At this time, it may be determined that the user and the publisher have the same preference for the media content, and thus the media content recommended by the publisher may be more in line with the personalized needs of the user.

Alternatively, the associated consumption data of the user for the media content may be determined, wherein the user is the user who currently performs the browsing operation on the at least one piece of recommended content.

The associated consumption data and the historical consumption data are acquired after the user and the publisher are fully authorized. For example, authorization prompt information may be popped up in the display page for the user and the publisher. After acquiring the authorization confirmation instruction from the user and the publisher, the associated consumption data and the historical consumption data are acquired.

Furthermore, the related browsing behavior between the user and the publisher may be determined based on the associated consumption data and the browsing data and/or the interaction data. The related browsing behavior may be the same or similar browsing behavior of the user and the publisher for the media content. For example, the related browsing behavior may be the same media content browsed by the user and the publisher. Determination of the related browsing data may be implemented by calculating an intersection between the associated consumption data and the browsing data. Therefore, after determining the related browsing behavior, the content consumption feature label associated with the publisher may be accurately determined based on the related browsing behavior.

As an implementation that may be implemented, the user may have browsed the same media content with the publisher historically. In a situation that the user and the publisher have browsed the same media content, it characterizes that both the user and the publisher are interested in similar media content, and thus the media content recommended by the publisher may be more in line with the personalized needs of the user. Whether the user and the publisher have browsed the same target media content historically is determined based on the associated consumption data and the browsing data. If the target media content exists, a first browsing parameter of the user for the target media content may be determined, and a second browsing parameter of the publisher for the target media content may be determined. In some embodiments, the first browsing parameter may be a browsing progress or viewing duration of the user for the target media content within a preset time range. In some embodiments, the second browsing parameter may be the browsing progress or viewing duration of the publisher for the target media content within the preset time range, or the publisher may add the media content to favorites, etc. If the first browsing parameter and the second browsing parameter satisfy a preset selection condition, the browsing behavior for the target media content is determined as the related browsing behavior. The preset selection condition may be that the browsing progress of the user and the publisher for the target media content is greater than a preset progress threshold and the viewing duration is greater than a preset duration. Alternatively, the user and the publisher may correspond to different selection conditions. In some embodiments, the preset selection condition may be set by the user according to actual needs, or may be a system default, which is not limited by the present disclosure. Taking the target media content as a target book for an example. If the cumulative listening and reading time of the user for the target book within the last 14 days is greater than or equal to 30 minutes, or the cumulative reading progress is greater than 50% of the whole book, and the cumulative listening and reading time of the publisher for the target book within the last 14 days is greater than 10 minutes, and the browsing progress is greater than 50%, it is determined that the user and the publisher are currently reading the same book. Alternatively, in order to implement determination of the content consumption feature label, a first label text may be preset. The first label text is a label text corresponding to a scenario in which the user and the publisher have recently browsed the same media content. The first label text may be “She/He has also been reading XX recently.” After determining that the user and the publisher have browsed the same target media content historically, the first label text may be adjusted based on the target media content to obtain the content consumption feature label. For example, the first label text may be adjusted to “She/He has also been reading the target media content recently.”

As an implementation that may be implemented, the user and the publisher may both prefer the same type of media content. It may be determined that the user and the publisher have the same preference for the media content, and thus the media content recommended by the publisher may be more in line with the personalized needs of the user. Alternatively, at least one media content type that has been browsed by both the user and the publisher may be determined based on the associated consumption data and the browsing data. A plurality of media content types that have been browsed by the user historically and a plurality of media content types that have been browsed by the publisher historically may be counted. An intersection between the two may be taken as at least one media content type that has been browsed by both the user and the publisher. Furthermore, the at least one media content type may be sorted according to a preset sorting manner and the browsing duration of the user for the media content, to obtain the sorted media content type. The at least one media content type may be sorted in an order of browsing durations from long to short. At least one media content type ranked higher than a preset ranking threshold in the sorted media content types is determined as the related browsing behavior. For example, the ranking threshold may be 2, that is, the media content type with the longest browsing duration may be determined as the current target media content type. Alternatively, a second label text may be preset. The second label text is a label text corresponding to a scenario where the user and the publisher like browsing media content of the same media content type. The second label text may be “She/He also likes to read XX articles.” After determining that the user and the publisher have browsed the same target media type historically, the second label text may be adjusted based on the target media type to obtain the content consumption feature label. For example, the second label text may be adjusted to “She/He also likes to read rebirth articles.”

As an implementation that may be implemented, the user may have published comment information for the same media content as the publisher. It characterizes that the user and the publisher were interested in the same media content historically, and their browsing preferences for the media content may be similar. Alternatively, at least one piece of media content historically commented by the publisher is determined based on the interaction data, and at least one piece of media content historically commented by the user is determined based on the associated consumption data. At least one piece of target media content commented by both the user and the publisher is determined. An intersection between the at least one piece of media content historically commented by the publisher and the at least one piece of media content historically commented by the user may be calculated to determine the at least one piece of media content. An adjustment operation is performed on the preset third label text based on identification information corresponding to the at least one piece of target media content to obtain the content consumption feature label. In some embodiments, the third label text may be a label text corresponding to a scenario in which the user and the publisher have historically commented the same target media content. It may be “She/He also liked XX.” After determining the target book historically commented by the user and the publisher, the fourth label text may be adjusted to “She/He also liked the target media content.” Alternatively, in a situation that the user and the publisher have historically commented a plurality of pieces of the same media content, score information of each piece of media content may be determined, and the media content with the highest score is determined as the current target media content.

As an implementation that may be implemented, when the user or the publisher browses media content in the target application, desired media content may be recommended according to actual needs. If the user and the publisher give a good review to the same media content at the same time, it may characterize that the browsing preferences of the user and the publisher for the media content overlap. Therefore, the media content recommended by the publisher may be more in line with the personalized needs of the user. Alternatively, after acquiring the associated consumption data and the interaction data associated with the publisher respectively, at least one piece of recommended media content historically recommended by the publisher may be determined based on the interaction data, and at least one piece of recommended media content historically recommended by the user may be determined based on the associated consumption data. An intersection between the at least one piece of recommended media content historically recommended by the publisher and the at least one piece of recommended media content historically recommended by the user is calculated to determine at least one piece of target media content recommended by both the user and the publisher. The adjustment operation is performed on the preset fourth label text based on identification information corresponding to the at least one piece of target media content to obtain the content consumption feature label. The fourth label text may be a label text corresponding to a scenario in which the user and the publisher have recommended the same media content. For example, the fourth label text may be “She/He has also recommended XX.” After determining the at least one piece of target media content recommended by both the user and the publisher based on the historical consumption data, the fourth label text may be adjusted to “She/He has also recommended the target media content,” to obtain the content consumption feature label associated with the publisher. Alternatively, when the user and the publisher have historically recommended a plurality of pieces of the same media content, score information of each piece of media content may be determined, and the media content with the highest score is determined as the current target media content. Accordingly, when the user browses the recommended content in the content display page associated with the preset theme, the browsing preferences of the publisher may be understood based on the content consumption feature label, and then the media content recommended by the publisher may be browsed in a targeted manner.

According to the method for displaying content provided in this embodiment, the associated consumption data corresponding to the user is determined, so that the related browsing data associated between the user and the publisher who publishes the recommended content may be determined based on the associated consumption data and the browsing data and/or the interaction data. Thus, the at least one content consumption feature label associated with the publisher may be accurately determined based on the related browsing data. The content consumption feature label may characterize the same or similar browsing styles of the user and the publisher in the media content browsing operation.

Furthermore, based on any of the above embodiments, step 403 may include: determining, based on the browsing data, browsing feature information of the publisher for the media content, the browsing feature information including at least one media content category with browsing duration reaching a preset duration threshold, and a historical browsing age of the publisher; and determining at least one content consumption feature label associated with the publisher based on the browsing feature information.

In this example, after determining the browsing data associated with the publisher, the browsing feature information of the publisher for the media content may be determined based on the browsing data. In some embodiments, the browsing feature information may include at least one media content category with browsing duration of the publisher reaching the preset duration threshold, and the historical browsing age of the publisher. The at least one content consumption feature label associated with the publisher is determined based on the browsing characteristic information.

As an implementation that may be implemented, when there is no intersection in the historical browsing media content of the user and that of the publisher, the browsing preferences of the publisher for the media content may also be determined, and the content consumption feature label corresponding to the publisher may be determined based on the browsing preferences. Alternatively, after acquiring browsing data corresponding to the publisher, as each piece of media content may be associated with a preset type label, at least one media content type of each piece of media content browsed by the publisher historically and a historical browsing duration corresponding to each media content type may be determined according to the browsing data. In some embodiments, at least one piece of media content corresponding to each media content type may be determined in the historical consumption data, and the browsing durations of the at least one piece of media content may be accumulated to obtain the historical browsing duration corresponding to each media content type. Furthermore, the at least one media content type is sorted according to a preset sorting manner and the historical browsing duration of each media content type, to obtain the at least one sorted media content type. For example, the at least one media content type may be sorted in an order of historical browsing duration from high to low. At least one media content type ranked higher than a preset ranking threshold in the at least one sorted media content type is determined. In some embodiments, the ranking threshold may be 2, that is, the media content type with the longest historical browsing duration may be determined as the current target media content type. The adjustment operation is performed on the preset fifth label text based on the at least one media content type to obtain the content consumption feature label. In some embodiments, the fifth label text may be a label text corresponding to a scenario in which the publisher has browsed the most media content type historically. It may be “She/He literature fan.” After determining the target media content type, the fifth label text may be adjusted to “strategy literature fan.”

According to the method for displaying content provided in this embodiment, the browsing feature information of the publisher for the media content is determined based on the browsing data, and the at least one content consumption feature label associated with the publisher is determined based on the browsing feature information, so that when browsing the recommended content, the user may know the browsing preferences of the publisher, and then the user may view the media content recommended by the publisher according to the browsing preferences of the publisher in a targeted manner.

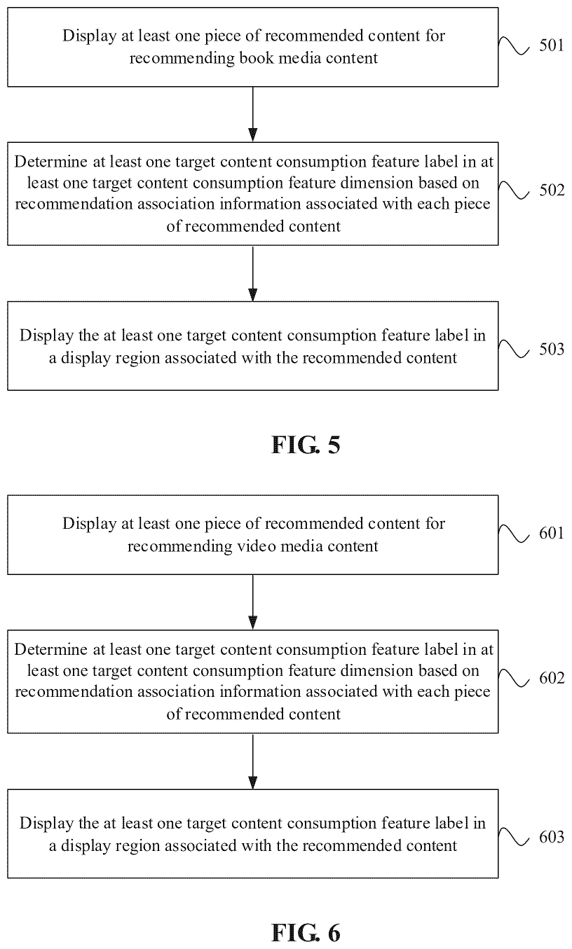

FIG. 5 is a schematic flowchart of a method for displaying content provided by another embodiment of the present disclosure. Based on any of the above embodiments, as shown in FIG. 5, the method further includes the following steps.

Step 501: displaying at least one piece of recommended content for recommending book media content, wherein a publisher of the recommended content is associated with at least one piece of content consumption feature label related to a browsing behavior of the book media content.

Step 502: determining at least one target content consumption feature label in at least one target content consumption feature dimension based on recommendation association information associated with each piece of recommended content. In some embodiments, the recommendation association information includes one or more of the followings: at least one book to be recommended in the recommended content, recommendation data generated by the publisher based on the at least one book to be recommended, and an interactive topic associated with the at least one piece of recommended content.

Step 503: displaying the at least one target content consumption feature label in a display region associated with the recommended content, so that the user views the recommended content based on the at least one target content consumption feature label.

In this embodiment, the media content to be recommended may be the book media content. The publisher may generate and publish recommended content for at least one piece of book media content that is of interest according to actual needs, to implement the recommendation operation for the at least one piece of book media content.

Alternatively, the user may browse the recommended content, to implement discovery and browsing of richer book media content. At least one piece of recommended content for recommending the book media content is displayed, and the publisher of the recommended content is associated with at least one piece of content consumption feature label related to a browsing behavior of the book media content. For example, the content consumption label may be “She/He is also reading book A,” “She/He is also a strategy literature fan,” etc.

In the process of browsing the at least one piece of recommended content by the user, in order to enable the user to discover desired book media content more quickly and accurately, the content consumption feature label associated with the publisher may be displayed in the recommended content. Thus, when browsing the recommended content, the user may have an initial impression about the browsing style of the publisher based on the content consumption feature label, and then may discover the book media content based on the browsing style in a targeted manner.

Alternatively, as there may be at least one content consumption feature label associated with the publisher, in order to enable the target content consumption feature label displayed in the current recommended content to be more in line with the current recommendation scene, at least one target content consumption feature label that matches the current recommendation scene more may also be determined from the at least one piece of content consumption feature label.

Alternatively, the content consumption feature label may correspond to different content consumption feature dimensions. In some embodiments, the content consumption feature dimension may include, but not limited to, an author dimension associated with the media content, a type dimension for recommended media content, a browsing age dimension for the media content, etc. Taking the content consumption feature dimension as the type dimension of the book media content for an example. The content consumption feature dimension may correspond to content consumption feature labels such as a novice literature fan, an intermediate and advanced literature fan, a strategy literature fan, a romance literature fan, etc.

As the content consumption feature label corresponds to different content consumption feature dimensions, the target content consumption feature dimension may be determined based on the associated data, and the at least one target content consumption feature label may be further determined, based on the associated data, from the at least one content consumption feature label associated with the target content consumption feature dimension.

The at least one target content consumption feature label is displayed in the display region associated with the recommended content, so that the user views the recommended content based on the at least one target content consumption feature label.

According to the method for displaying content provided in this embodiment, when displaying the at least one piece of recommended content for recommending the book media content, at least one target content consumption feature label in at least one target content consumption feature dimension is determined based on associated data corresponding to the recommended content, and the at least one target content consumption feature label is displayed in the recommended content, so that a personalized label of the publisher associated with the recommendation scene may be displayed in the recommended content. The user may locate the publisher with the same or similar consumption behavior through the target content consumption feature label more accurately, and view the book media content recommended by the publisher, thereby the efficiency and accuracy of book media content discovery can be improved.

FIG. 6 is a schematic flowchart of a method for displaying content provided according to another embodiment of the present disclosure. Based on any of the above embodiments, as shown in FIG. 6, the method further includes the following steps.

Step 601: displaying at least one piece of recommended content for recommending video media content. In some embodiments, a publisher of the recommended content is associated with at least one content consumption feature label related to a browsing behavior for the video media content.

Step 602: determining at least one target content consumption feature label in at least one target content consumption feature dimension based on recommendation association information associated with each piece of recommended content. In some embodiments, the recommendation association information includes one or more of the followings: at least one video to be recommended in the recommended content, recommendation data generated by the publisher based on the at least one video to be recommended, and an interactive topic associated with the at least one piece of recommended content.

Step 603: displaying the at least one target content consumption feature label in a display region associated with the recommended content, so that the user views the recommended content based on the at least one target content consumption feature label.

In this embodiment, the media content to be recommended may be the video media content. The publisher may generate and publish recommended content for at least one piece of video media content that is of interest according to actual needs, to implement a recommendation operation for the at least one piece of video media content.

Alternatively, the user may browse the recommended content, to implement discovery and browsing of richer video media content. At least one piece of recommended content for recommending the video media content is displayed, and the publisher who recommends the content is associated with at least one piece of content consumption feature label related to a browsing behavior for the video media content. For example, the content consumption label may be “He/She is also watching video A,” “He/She is also a palace fighting drama fan,” etc.

In the process of browsing the at least one piece of recommended content by the user, in order to enable the user to discover the desired video media content more quickly and accurately, the content consumption feature label associated with the publisher may be displayed in the recommended content. Thus, when browsing the recommended content, the user may have an initial impression about the browsing style of the publisher based on the content consumption feature label, and then may discover the video media content based on the browsing style in a more targeted manner.

Alternatively, as there may be at least one piece of content consumption feature label associated with the publisher, in order to enable the target content consumption feature label displayed in the current recommended content to be more in line with the current recommendation scene, at least one target content consumption feature label that matches the current recommendation scene more may also be determined from the at least one piece of content consumption feature label.

Alternatively, the content consumption feature label corresponds to different content consumption feature dimensions. In some embodiments, the content consumption feature dimension includes, but is not limited to, an author dimension associated with the media content, a type dimension of recommended media content, a browsing age dimension for the media content, etc. Taking the content consumption feature dimension as the type dimension of video media content for an example, the content consumption feature dimension may correspond to content consumption feature labels such as a novice literature fan, an intermediate and advanced literature fan, a strategy literature fan, a romance literature fan, etc.

As the content consumption feature label corresponds to different content consumption feature dimensions, the target content consumption feature dimension may be determined based on associated data, and at least one target content consumption feature label may be further determined, based on the associated data, from at least one piece of content consumption feature label associated with the target content consumption feature dimension.

The at least one target content consumption feature label is displayed in the display region associated with the recommended content, so that the user views the recommended content based on the at least one target content consumption feature label.

According to the method for displaying content provided in this embodiment, when displaying the at least one piece of recommended content for recommending the video media content, at least one target content consumption feature label in the at least one target content consumption feature dimension is determined based on associated data corresponding to the recommended content, and the at least one target content consumption feature label is displayed in the recommended content, so that a personalized label of the publisher associated with recommendation scene may be displayed in the recommended content. The user may locate the publisher with the same or similar consumption behavior through the target content consumption feature label more accurately, and may view the video media content recommended by the publisher, thereby the efficiency and accuracy of video media content discovery may be improved.

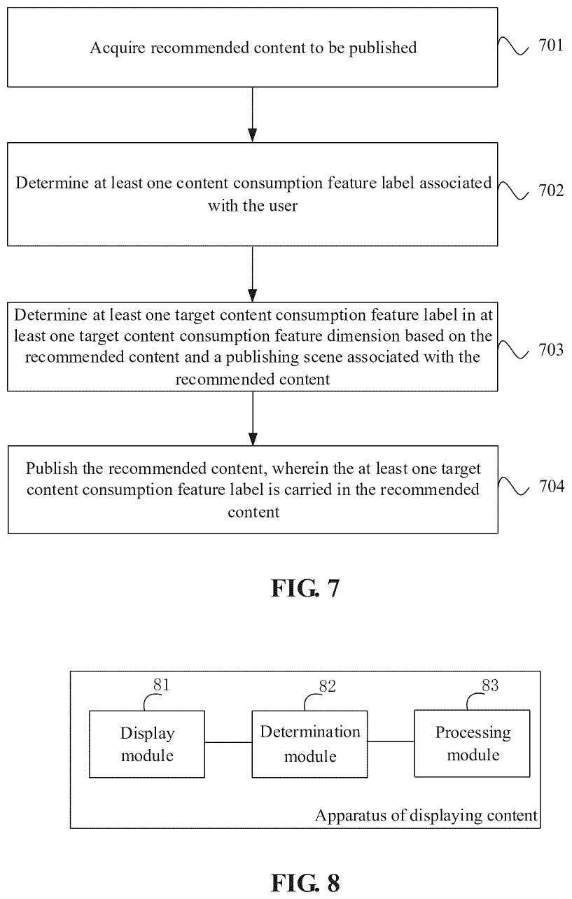

FIG. 7 is a schematic flowchart of a method for displaying content provided according to an embodiment of the present disclosure. As shown in FIG. 7, the method further includes the following steps.

Step 701: acquiring recommended content to be published, wherein the recommended content to be published includes at least one piece of media content to be recommended and recommendation data generated based on the at least one piece of media content to be recommended.

Step 702: determining at least one content consumption feature label associated with the user, wherein the content consumption feature label is generated based on historical consumption data of the user for the media content.

Step 703: determining at least one target content consumption feature label in at least one target content consumption feature dimension based on the recommended content and a publishing scene associated with the recommended content.

Step 704: publishing the recommended content and carrying the at least one target content consumption feature label in the recommended content.

An execution subject according to this embodiment is an apparatus for displaying content. The apparatus for displaying content may be coupled to a server, the server can be in communication connection with a terminal device, so that the at least one target content consumption feature label in the at least one target content consumption feature dimension may be determined based on the recommended content publishing operation triggered by the user on the terminal device, and the at least one target content consumption feature label is carried when the recommended content is published.

According to this embodiment, the user may publish the recommended content according to actual needs, to implement a recommendation operation for the media content.

Alternatively, the recommended content to be published may be acquired. In some embodiments, the recommended content to be published includes at least one piece of media content to be recommended and recommendation data generated based on the at least one piece of media content to be recommended. For example, the recommended content may include at least one recommended book determined by the user, and the recommendation text and the recommendation image generated by the user for each recommended book, etc.

Further, in order to enable the viewer of the recommended content to discover the media content based on the recommended content more quickly and accurately, the content consumption feature label capable of characterizing personalized consumption behavior of the user may be carried in the recommended content.

Therefore, historical consumption data associated with the user may be acquired, and at least one content consumption feature label associated with the user may be determined based on the historical consumption data.

Furthermore, a publishing scene associated with the recommended content may be determined. In some embodiments, the publishing scene of the recommended content includes, but is not limited to, interactive topic content for publishing the recommended content, a recommendation list for publishing the recommended content, etc. Thus, at least one target content consumption feature label may be determined, from at least one content consumption feature label associated with the user, based on the recommended content and the publishing scene associated with the recommended content.

As an implementation that may be implemented, the content consumption feature label may be associated with different content consumption feature dimensions. After respectively determining the recommended content and the publishing scene associated with the recommended content, a current target content consumption feature dimension may be determined based on the recommended content and the publishing scene associated with the recommended content. At least one target content consumption feature label is further determined, based on the recommended content and the publishing scene associated with the recommended content, from the at least one content consumption feature label associated with the target content consumption feature dimension.

After acquiring the recommended content and the at least one target content consumption feature label respectively, the recommended content may be published in response to a publish operation triggered by the user, and the at least one target content consumption feature label is carried in the recommended content.

According to the method for displaying content provided in this embodiment, when the user generates recommended content, at least one target content consumption feature label in at least one target content consumption feature dimension is determined based on the recommended content and a publishing scene associated with the recommended content, so that at least one target content consumption feature label may be carried when the recommended content is published. Thus, after the recommended content is published, another user may view the recommended content published by the user in a targeted manner based on the at least one target content consumption feature label corresponding to the user.

FIG. 8 is a schematic structural diagram of an apparatus for displaying content provided according to an embodiment of the present disclosure. As shown in FIG. 8, the apparatus includes a display module 81, a determination module 82 and a processing module 83. The display module 81 is configured to display at least one piece of recommended content for recommending media content, wherein a publisher of the recommended content is associated with at least one piece of content consumption feature label, and the content consumption feature label is generated based on historical consumption data of the publisher for the media content. The content consumption feature label corresponds to different content consumption feature dimensions. The determination module 82 is configured to determine at least one target content consumption feature label in at least one target content consumption feature dimension based on associated data corresponding to the recommended content. The processing module 83 is configured to display the at least one target content consumption feature label in the recommended content.

Furthermore, based on any of the above embodiments, the determination module is configured to determine feature information corresponding to the associated data, and determine the at least one target content consumption feature label in the at least one target content consumption feature dimension based on the feature information.

Furthermore, based on any of the above embodiments, the associated data includes at least one piece of media content to be recommended that is corresponding to the recommended content. The determination module is configured to acquire first parameter information associated with the at least one piece of media content, wherein the first parameter information includes basic information and historical interaction information corresponding to the at least one piece of media content. The determination module is configured to determine feature information associated with the at least one piece of media content based on the first parameter information, wherein the feature information includes category information, creator information, and content type information corresponding to the at least one piece of media content.

Furthermore, based on any of the above embodiments, the associated data includes recommendation data in the recommended content, wherein the recommendation data includes a recommendation text and/or a recommendation image. The determination module is configured to identify a text keyword in the recommendation text, and/or identify an image feature corresponding to the recommendation image. The determination module is configured to determine the text keyword and/or the image content as the feature information.

Furthermore, based on any of the above embodiments, the associated data includes a target interactive topic associated with the at least one piece of recommended content. The determination module is configured to determine at least one keyword associated with the recommended content in the target interactive topic. The determination module is configured to determine the at least one keyword as the feature information.

Furthermore, based on any of the above embodiments, the determination module is configured to determine, for each content consumption feature label, similarity information between the content consumption feature label and the feature information; and determine at least one content consumption feature label with similarity information satisfying a preset condition as the at least one target content consumption feature label.

Furthermore, based on any of the above embodiments, the determination module is configured to determine, from a plurality of content consumption feature dimensions, a target content consumption feature dimension matching at least partial feature information based on the at least partial feature information; and determine, from the at least one content consumption feature label corresponding to the target content consumption feature dimension, at least one target content consumption feature label matching remaining feature information based on the remaining feature information.

Furthermore, based on any of the above embodiments, the display module is configured to display at least one piece of interactive topic content in a preset interactive page; in response to a trigger operation performed by the user for any piece of the interactive topic content, display a content display page associated with the interactive topic content; and display the at least one piece of recommended content related to the interactive topic content in the content display page.

Furthermore, based on any of the above embodiments, the display module is configured to display at least one piece of interactive topic content historically published by the user in a preset information page; in response to a trigger operation performed by the user for any piece of the interactive topic content, display a content display page associated with the interactive topic content; and display the at least one piece of recommended content related to the interactive topic content in the content display page.

Furthermore, based on any of the above embodiments, the display module is configured to display a preset content recommendation list, wherein the content recommendation list includes at least one recommendation topic; in response to a trigger operation performed by the user for any recommendation topic, display the content display page associated with the recommendation topic; and display the at least one piece of recommended content related to the recommendation topic in the content display page.

Furthermore, based on any of the above embodiments, the apparatus further includes a data acquisition module, a determination module and a processing module. The data acquisition module is configured to acquire, for each piece of recommended content, historical consumption data of the publisher corresponding to the recommended content. The determination module is configured to determine browsing data and interaction data of the publisher for the media content based on the historical consumption data, wherein the browsing data at least includes a corresponding browsing duration for each piece of media content, and the interaction data includes comment content and/or recommended content published by the publisher for the media content. The processing module is configured to determine the at least one content consumption feature label associated with the publisher according to the browsing data and/or the interaction data.

Furthermore, based on any of the above embodiments, the processing module is configured to acquire associated consumption data of the user for the media content, wherein the user is the user who performs a browsing operation on the at least one piece of recommended content. The processing module is configured to determine related browsing behavior between the user and the publisher based on the associated consumption data and the browsing data and/or the interaction data. The processing module is configured to determine the at least one content consumption feature label associated with the publisher based on the related browsing behavior.

Furthermore, based on any of the above embodiments, the processing module is configured to determine, based on the browsing data, browsing feature information of the publisher for the media content, wherein the browsing feature information includes at least one media content category with browsing duration of the publisher reaching a preset duration threshold, and a historical browsing age of the publisher. The processing module is configured to determine the at least one content consumption feature label associated with the publisher based on the browsing feature information.

Furthermore, based on any of the above embodiments, the apparatus further includes a display module, a determination module and a processing module. The display module is configured to display at least one piece of recommended content for recommending book media content, and the publisher of the recommended content is associated with at least one content consumption feature label related to a browsing behavior for the book media content. The determination module is configured to determine at least one target content consumption feature label in at least one target content consumption feature dimension based on the recommendation association information associated with each piece of recommended content, wherein the recommendation association information includes one or more of the followings: at least one book to be recommended in the recommended content, recommendation data generated by the publisher based on the at least one book to be recommended, and interactive topic associated with the at least one piece of recommended content. The processing module is configured to display the at least one target content consumption feature label in the display region associated with the recommended content, so that the user views the recommended content based on the at least one target content consumption feature label.

Furthermore, based on any of the above embodiments, the method further includes: a display module, a determination module and a processing module. The display module is configured to display at least one piece of recommended content for recommending video media content, and the publisher of the recommended content is associated with at least one content consumption feature label related to a browsing behavior for the video media content. The determination module is configured to determine at least one target content consumption feature label in at least one target content consumption feature dimension based on recommendation association information associated with each piece of recommended content, wherein the recommendation association information includes one or more of the followings: at least one video to be recommended in the recommended content, recommendation data generated by the publisher based on the at least one video to be recommended, and an interactive topic associated with the at least one piece of recommended content. The processing module is configured to display the at least one target content consumption feature label in the display region associated with the recommended content, so that the user may view the recommended content based on the at least one target content consumption feature label.

FIG. 9 is a schematic structural diagram of an apparatus for displaying content provided according to an embodiment of the present disclosure. As shown in FIG. 9, the apparatus includes an acquisition module 91, a generation module 92, a selection module 93 and a publishing module 94. In some embodiments, the acquisition module 91 is configured to acquire recommended content to be published, wherein the recommended content to be published includes at least one piece of media content to be recommended and recommendation data generated based on the at least one piece of media content to be recommended. The generation module 92 is configured to determine at least one piece of content consumption feature label associated with the user, wherein the content consumption feature label is generated based on historical consumption data of the user for the media content. The selection module 93 is configured to determine at least one target content consumption feature label in at least one target content consumption feature dimension based on the recommended content and a publishing scene associated with the recommended content. The publishing module 94 is configured to publish the recommended content, wherein the at least one target content consumption feature label is carried in the recommended content.

The device provided according to this embodiment may be configured to implement the technical solution of the above method embodiment, and the implementation principle and the technical effect thereof are similar, which will not be repeated in this embodiment.

In order to implement the above embodiments, a computer-readable storage medium is provided according to an embodiment of the present disclosure. The computer-readable storage medium stores computer-executable instructions. When a processor executes the computer-executable instructions, the method for displaying content according to any of the above embodiments is implemented.

In order to implement the above embodiments, a computer program product is provided according to an embodiment of the present disclosure. The computer program product includes a computer program, wherein when the computer program is executed by a processor, the method for displaying content according to any of the above embodiments is implemented.

In order to implement the above embodiments, an electronic device is provided according to an embodiment of the present disclosure. The electronic device includes a processor and a memory. The memory stores computer-executable instructions. The processor executes the computer-executable instructions stored in the memory, to enable the processor to execute the method for displaying content according to any of the above embodiments.

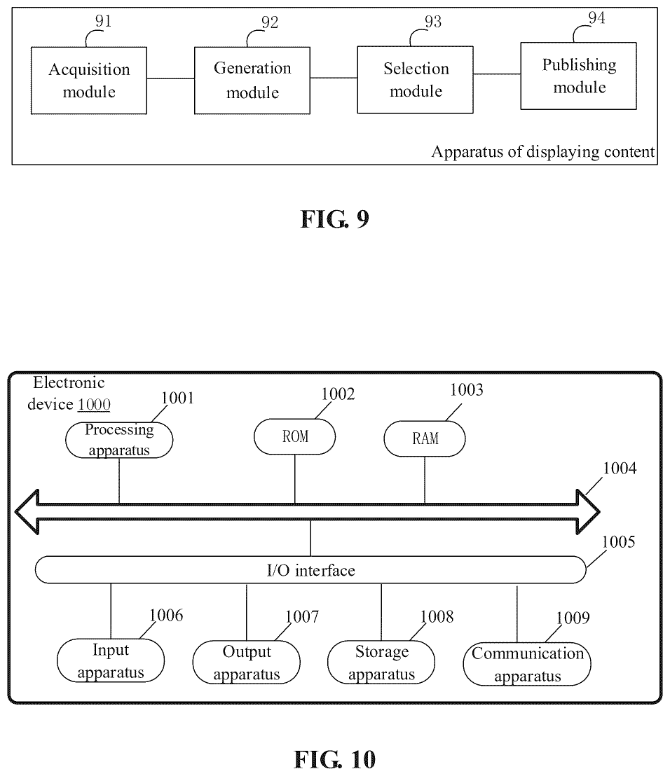

FIG. 10 is a schematic structural diagram of an electronic device provided according to an embodiment of the present disclosure. The electronic device 1000 may be a terminal device or a server. In some embodiments, the terminal device may include, but is not limited to, a mobile terminal such as a mobile phone, a laptop, a digital broadcast receiver, a personal digital assistant (PDA), a tablet computer (PAD), a portable media player (PMP), a vehicle-mounted terminal (such as a vehicle-mounted navigation terminal), etc., and a fixed terminal such as a digital TV, a desktop computer, etc. The electronic device shown in FIG. 10 is only an example, and should not bring any limitation to the function and scope of implementation of the embodiments of the present disclosure.

As shown in FIG. 10, the electronic device 1000 may include a processing apparatus (such as a central processing unit, a graphics processor, etc.) 1001, which may perform various appropriate actions and processing according to a program stored in a read-only memory (ROM) 1002 or a program loaded from a storage apparatus 1008 into a random access memory (RAM) 1003. The RAM 1003 also stores various programs and data required for operations of the electronic device 1000. The processing apparatus 1001, the ROM 1002, and the RAM 1003 are connected to each other through a bus 1004. An input/output (I/O) interface 1005 is also connected to the bus 1004.

Generally, following apparatuses may be connected to the I/O interface 1005: an input apparatus 1006, including, for example, a touchscreen, a touchpad, a keyboard, a mouse, a camera, a microphone, an accelerometer, a gyroscope, etc.; an output apparatus 1007, including, for example, a liquid crystal display (LCD), a loudspeaker, a vibrator, etc.; a storage apparatus 1008, including, for example, a magnetic tape, a hard disk, etc.; and a communication apparatus 1009. The communication apparatus 1009 may allow the electronic device 1000 to perform wireless or wired communication with another device to exchange data. Although FIG. 10 shows the electronic device 1000 with various apparatuses, it should be understood that not all the illustrated apparatuses are required to be implemented or provided. More or fewer apparatuses may alternatively be implemented or provided.

In particular, according to embodiments of the present disclosure, the processes described above with reference to the flowcharts may be implemented as computer software programs. For example, a computer program product is included according to an embodiment of the present disclosure. The computer program product includes a computer program carried on a computer-readable medium, and the computer program includes program codes for executing the method shown in the flowcharts. In such an embodiment, the computer program may be downloaded and installed from the network through the communication apparatus 1009, or installed from the storage apparatus 1008, or installed from the ROM 1002. When the computer program is executed by the processing apparatus 1001, the above-mentioned functions defined in the method according to embodiments of the present disclosure are executed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that may be used by or in combination with an instruction execution system, apparatus, or device. In the present disclosure, the computer-readable signal medium may include a data signal propagated in a baseband or as a part of a carrier wave, and a computer-readable program code is carried therein. The propagated data signal may take a variety of forms, including but not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to, a wire, an optical cable, RF (radio frequency), etc., or any suitable combination thereof.

The computer-readable medium described above may be included in the electronic device described above or may also exist alone without being assembled into the electronic device.

The computer-readable medium described above carries one or more programs. When the one or more programs described above are executed by the electronic device, the electronic device is caused to execute the method as shown in the embodiments described above.

The computer program codes used to perform operations of the present disclosure may be written in one or more programming languages or a combination thereof, and the above programming languages include object-oriented programming languages such as Java, Smalltalk, C++, and also include conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case of involving a remote computer, the remote computer may be connected to the user's computer through any kind of network, including a local area network (LAN) or a wide area network (WAN), or may be connected to an external computer (for example, connected via the Internet provided by an Internet service provider).

The flowcharts and block diagrams in the drawings illustrate the architecture, functions, and operations of possible implementations of the system, method, and computer program product according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that in some alternative implementations, a function marked in a block may also occur in a different order from that marked in the drawings. For example, two blocks shown in succession may actually be executed substantially in parallel, or they may sometimes be executed in a reverse order, depending on the functions involved. It should also be noted that each block in the block diagrams and/or flowcharts, and a combination of blocks in the block diagrams and/or flowcharts, may be implemented by a dedicated hardware-based system that performs the specified functions or operations, or may be implemented by a combination of dedicated hardware and computer instructions.

The units involved in the embodiments of the present disclosure may be implemented by software or hardware. The name of a unit does not constitute a limitation to the unit itself under certain circumstances. For example, the first acquisition unit may also be described as “a unit for acquiring at least two Internet protocol addresses.”

The functions described herein above may be performed, at least partially, by one or more hardware logic components. For example, without limitation, exemplary types of hardware logic components that may be used may include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

In a first aspect, according to one or more embodiments of the present disclosure, a method for displaying content is provided, including: displaying at least one piece of recommended content for recommending media content, wherein a publisher of the recommended content is associated with at least one content consumption feature label, the content consumption feature label is generated based on historical consumption data of the publisher for the media content, the content consumption feature label corresponds to different content consumption feature dimensions; determining at least one target content consumption feature label in at least one target content consumption feature dimension based on associated data corresponding to the recommended content; and displaying the at least one target content consumption feature label in the recommended content.

According to one or more embodiments of the present disclosure, determining at least one target content consumption feature label in at least one target content consumption feature dimension based on associated data corresponding to the recommended content includes: determining feature information corresponding to the associated data; and determining the at least one target content consumption feature label in the at least one target content consumption feature dimension based on the feature information.

According to one or more embodiments of the present disclosure, the associated data includes at least one piece of media content to be recommended corresponding to the recommended content; wherein determining feature information corresponding to the associated data includes: acquiring first parameter information associated with the at least one piece of media content, wherein the first parameter information includes basic information and historical interaction information corresponding to the at least one piece of media content; and determining the feature information associated with the at least one piece of media content based on the first parameter information, wherein the feature information includes category information, creator information, and content type information corresponding to the at least one piece of media content.

According to one or more embodiments of the present disclosure, the associated data includes recommendation data in the recommended content, wherein the recommendation data includes a recommendation text and/or a recommendation image; and determining feature information corresponding to the associated data includes: identifying a text keyword in the recommendation text, and/or identifying an image feature corresponding to the recommendation image; and determining the text keyword and/or the image content as the feature information.

According to one or more embodiments of the present disclosure, the associated data includes a target interactive topic associated with the at least one piece of recommended content; wherein determining feature information corresponding to the associated data includes: determining at least one keyword associated with the recommended content in the target interactive topic; and determining the at least one keyword as the feature information.

According to one or more embodiments of the present disclosure, determining the at least one target content consumption feature label in the at least one target content consumption feature dimension based on the feature information includes: determining, for each content consumption feature label, similarity information between the content consumption feature label and the feature information; and determining at least one content consumption feature label with similarity information satisfying a preset condition as the at least one target content consumption feature label.

According to one or more embodiments of the present disclosure, determining the at least one target content consumption feature label in the at least one target content consumption feature dimension based on the feature information includes: determining, from a plurality of content consumption feature dimensions, a target content consumption feature dimension matching at least partial feature information based on the at least partial feature information; and determining, from at least one content consumption feature label corresponding to the target content consumption feature dimension, at least one target content consumption feature label matching remaining feature information based on the remaining feature information.

According to one or more embodiments of the present disclosure, displaying at least one piece of recommended content for recommending media content includes: displaying at least one piece of interactive topic content in a preset interactive page; in response to a trigger operation performed by the user for any piece of the interactive topic content, displaying a content display page associated with the interactive topic content; and displaying the at least one piece of recommended content related to the interactive topic content in the content display page.

According to one or more embodiments of the present disclosure, displaying at least one piece of recommended content for recommending media content includes: displaying at least one piece of interactive topic content historically published by the user in a preset information page; in response to a trigger operation performed by the user for any piece of the interactive topic content, displaying a content display page associated with the interactive topic content; and displaying the at least one piece of recommended content related to the interactive topic content in the content display page.

According to one or more embodiments of the present disclosure, displaying at least one piece of recommended content for recommending media content includes: displaying a preset content recommendation list, wherein the content recommendation list includes at least one recommendation topic; in response to a trigger operation performed by the user for any recommendation topic, displaying a content display page associated with the recommendation topic; and displaying the at least one piece of recommended content related to the recommendation topic in the content display page.

According to one or more embodiments of the present disclosure, after displaying the at least one piece of recommended content for recommending media content, the method further includes: acquiring, for each piece of recommended content, the historical consumption data of the publisher corresponding to the recommended content; determining browsing data and interaction data of the publisher for the media content based on the historical consumption data, wherein the browsing data at least includes a browsing duration corresponding to each piece of media content, and the interaction data includes comment content and/or recommended content published by the publisher for the media content; and determining at least one content consumption feature label associated with the publisher based on the browsing data and/or the interaction data.

According to one or more embodiments of the present disclosure, determining the at least one content consumption feature label associated with the publisher based on the browsing data and/or the interaction data includes: acquiring associated consumption data of the user for the media content, wherein the user is the user who performs a browsing operation on the at least one piece of recommended content; determining a related browsing behavior between the user and the publisher based on the associated consumption data and the browsing data and/or the interaction data; and determining the at least one content consumption feature label associated with the publisher based on the related browsing behavior.

According to one or more embodiments of the present disclosure, determining the at least one content consumption feature label associated with the publisher based on the browsing data and/or the interaction data includes: determining browsing feature information of the publisher for the media content, based on the browsing data, wherein the browsing feature information includes at least one media content category with browsing duration of the publisher reaching a preset duration threshold and historical browsing age of the publisher; and determining the at least one content consumption feature label associated with the publisher based on the browsing feature information.

According to one or more embodiments of the present disclosure, the method further includes: displaying at least one piece of recommended content for recommending book media content, wherein a publisher of the recommended content is associated with at least one content consumption feature label related to a browsing behavior for the book media content; determining at least one target content consumption feature label in at least one target content consumption feature dimension based on recommendation association information associated with each piece of recommended content, wherein the recommendation association information includes one or more of the followings: at least one book to be recommended in the recommended content, recommendation data generated by the publisher based on the at least one book to be recommended, and an interactive topic associated with the at least one piece of recommended content; and displaying the at least one target content consumption feature label in a display region associated with the recommended content, so that the user views the recommended content based on the at least one target content consumption feature label.

According to one or more embodiments of the present disclosure, the method further includes: displaying at least one piece of recommended content for recommending video media content, wherein a publisher of the recommended content is associated with at least one content consumption feature label related to a browsing behavior for the video media content; determining at least one target content consumption feature label in at least one target content consumption feature dimension based on recommendation association information associated with each piece of recommended content, wherein the recommendation association information includes one or more of the followings: at least one video to be recommended in the recommended content, recommendation data generated by the publisher based on the at least one video to be recommended, and an interactive topic associated with the at least one piece of recommended content; and displaying the at least one target content consumption feature label in a display region associated with the recommended content, so that the user views the recommended content based on the at least one target content consumption feature label.

In a second aspect, according to one or more embodiments of the present disclosure, a method for displaying content is provided, including: acquiring recommended content to be published, wherein the recommended content to be published includes at least one piece of media content to be recommended and recommendation data generated based on the at least one piece of media content to be recommended; determining at least one piece of content consumption feature label associated with the user, wherein the content consumption feature label is generated based on historical consumption data of the user for the media content; determining at least one target content consumption feature label in at least one target content consumption feature dimension based on the recommended content and a publishing scene associated with the recommended content; and publishing the recommended content, wherein the at least one target content consumption feature label is carried in the recommended content.

In a second aspect, according to one or more embodiments of the present disclosure, an apparatus for displaying content is provided, including: a display module, configured to display at least one piece of recommended content for recommending media content, wherein a publisher of the recommended content is associated with at least one piece of content consumption feature label, the content consumption feature label is generated based on historical consumption data of the publisher for the media content, and the content consumption feature label corresponds to different content consumption feature dimensions; a determination module, configured to determine at least one target content consumption feature label in at least one target content consumption feature dimension based on associated data corresponding to the recommended content; and a processing module, configured to display the at least one target content consumption feature label in the recommended content.

According to one or more embodiments of the present disclosure, the determination module is configured to: determine feature information corresponding to the associated data; and determine the at least one target content consumption feature label in the at least one target content consumption feature dimension based on the feature information.

According to one or more embodiments of the present disclosure, the associated data includes at least one piece of media content to be recommended corresponding to the recommended content; the determination module is configured to: acquire first parameter information associated with the at least one piece of media content, wherein the first parameter information includes basic information and historical interaction information corresponding to the at least one piece of media content; and determine feature information associated with the at least one piece of media content based on the first parameter information, wherein the feature information includes category information, creator information, and content type information corresponding to the at least one piece of media content.

According to one or more embodiments of the present disclosure, the associated data includes recommendation data in the recommended content, wherein the recommendation data includes a recommendation text and/or a recommendation image; the determination module is configured to: identify a text keyword in the recommendation text, and/or identify an image feature corresponding to the recommendation image; and determine the text keyword and/or image content as the feature information.

According to one or more embodiments of the present disclosure, the associated data includes a target interactive topic associated with the at least one piece of recommended content;

the determination module is configured to: determine at least one keyword in the target interactive topic associated with the recommended content; and determine the at least one keyword as the feature information.

According to one or more embodiments of the present disclosure, the determination module is configured to: determine, for each content consumption feature label, similarity information between the content consumption feature label and the feature information; and determine at least one content consumption feature label with similarity information satisfying a preset condition as the at least one target content consumption feature label.

According to one or more embodiments of the present disclosure, the determination module is configured to: determine, from a plurality of content consumption feature dimensions, a target content consumption feature dimension matching at least partial feature information based on the at least partial feature information; and determine, from at least one content consumption feature label corresponding to the target content consumption feature dimension, at least one target content consumption feature label matching remaining feature information based on the remaining feature information.

According to one or more embodiments of the present disclosure, the display module is configured to: display at least one piece of interactive topic content in a preset interactive page; in response to a trigger operation performed by the user for any piece of the interactive topic content, display a content display page associated with the interactive topic content; and display the at least one piece of recommended content related to the interactive topic content in the content display page.

According to one or more embodiments of the present disclosure, the display module is configured to: display at least one piece of interactive topic content historically published by the user in a preset information page; in response to a trigger operation performed by the user for any piece of the interactive topic content, display a content display page associated with the interactive topic content; and display the at least one piece of recommended content related to the interactive topic content in the content display page.

According to one or more embodiments of the present disclosure, the display module is configured to: display a preset content recommendation list, wherein the content recommendation list includes at least one recommendation topic; in response to a trigger operation performed by the user for any recommendation topic, display a content display page associated with the recommendation topic; and display the at least one piece of recommended content related to the recommendation topic in the content display page.

According to one or more embodiments of the present disclosure, the apparatus further includes: a data acquisition module, configured to acquire, for each piece of recommended content, historical consumption data of the publisher corresponding to the recommended content; a determination module, configured to determine browsing data and interaction data of the publisher for the media content based on the historical consumption data, wherein the browsing data at least includes a browsing duration corresponding to each piece of media content, and the interaction data includes comment content and/or recommended content published by the publisher for the media content; and a processing module, configured to determine the at least one content consumption feature label associated with the publisher based on the browsing data and/or the interaction data.

According to one or more embodiments of the present disclosure, the processing module is configured to: acquire associated consumption data of the user for the media content, wherein the user is the user who performs a browsing operation on the at least one piece of recommended content; determine a related browsing behavior between the user and the publisher based on the associated consumption data and the browsing data and/or the interaction data; and determine the at least one content consumption feature label associated with the publisher based on the related browsing behavior.

According to one or more embodiments of the present disclosure, the processing module is configured to: determine browsing feature information of the publisher for the media content based on the browsing data, wherein the browsing feature information includes at least one media content category with browsing duration reaching the preset duration threshold, and a historical browsing age of the publisher; and determine the at least one content consumption feature label associated with the publisher based on the browsing feature information.

According to one or more embodiments of the present disclosure, the apparatus further includes: a display module, configured to display at least one piece of recommended content for recommending book media content, wherein the publisher of the recommended content is associated with at least one content consumption feature label related to a browsing behavior of the book media content; a determination module, configured to determine at least one target content consumption feature label in at least one target content consumption feature dimension based on recommendation association information associated with each piece of recommended content, wherein the recommendation association information includes one or more of the followings: at least one book to be recommended in the recommended content, recommendation data generated by the publisher based on the at least one book to be recommended, and an interactive topic associated with the at least one piece of recommended content; and a processing module, configured to display the at least one target content consumption feature label in a display region associated with the recommended content, so that the user views the recommended content based on the at least one target content consumption feature label.

According to one or more embodiments of the present disclosure, the method further includes: a display module, configured to display at least one piece of recommended content for recommending video media content, wherein the publisher of the recommended content is associated with at least one content consumption feature label related to a browsing behavior of the video media content; a determination module, configured to determine at least one target content consumption feature label in at least one target content consumption feature dimension based on recommendation association information associated with each piece of recommended content, wherein the recommendation association information includes at least one video to be recommended in the recommended content, recommendation data generated by the publisher based on the at least one video to be recommended, and an interactive topic associated with the at least one piece of recommended content; and a processing module, configured to display the at least one target content consumption feature label in a display region associated with the recommended content, so that the user views the recommended content based on the at least one target content consumption feature label.

In a fourth aspect, according to one or more embodiments of the present disclosure, an apparatus for displaying content is provided, including: an acquisition module, configured to acquire recommended content to be published, wherein the recommended content to be published includes at least one piece of media content to be recommended and recommendation data generated based on the at least one piece of media content to be recommended; a generation module, configured to determine at least one piece of content consumption feature label associated with the user, wherein the content consumption feature label is generated based on historical consumption data of the user for the media content; a selection module, configured to determine at least one target content consumption feature label in at least one target content consumption feature dimension based on the recommended content and a publishing scene associated with the recommended content; and a publishing module, configured to publish the recommended content, wherein the at least one target content consumption feature label is carried in the recommended content.

In a fifth aspect, according to one or more embodiments of the present disclosure, an electronic device is provided, including: at least one processor and a memory; the memory stores computer-executable instructions; and the at least one processor executes the computer-executable instructions stored in the memory, to enable the at least one processor to execute the method for displaying content according to the first aspect as described above and various possible designs of the first aspect.

In a sixth aspect, according to one or more embodiments of the present disclosure, a computer-readable storage medium is provided, wherein the computer-readable storage medium stores computer-executable instructions, and when a processor executes the computer-executable instructions, the method for displaying content according to the first aspect as described above and various possible designs of the first aspect is implemented.

In a seventh aspect, according to one or more embodiments of the present disclosure, a computer program product is provided, including a computer program, wherein when the computer program is executed by a processor, the method for displaying content according to the first aspect as described above and various possible designs of the first aspect is implemented.

The above description is only preferred embodiments of the present disclosure and an explanation of the applied technical principles. Those skilled in the art should understand that the scope of disclosure involved in the present disclosure is not limited to the technical solutions constituted by the specific combination of the above-mentioned technical features, and should also cover other technical solutions formed by any combination of the above-mentioned technical features or their equivalent features without departing from the above-mentioned disclosed concept. For example, the above-mentioned features and technical features with similar functions disclosed in the present disclosure (but not limited to) are replaced with each other to form a technical solution.

In addition, although operations are depicted in a particular order, this should not be understood as requiring that these operations are performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features that are described in the context of separate embodiments may also be implemented in a combination in a single embodiment. On the contrary, various features that are described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are only exemplary forms for implementing the claims.

What is claimed:

1. A method for displaying content, comprising:
displaying at least one piece of recommended content for recommending media content, wherein a publisher of the recommended content is associated with at least one content consumption feature label, wherein the content consumption feature label is generated based on historical consumption data of the publisher for the media content, and wherein the content consumption feature label corresponds to different content consumption feature dimensions;
determining at least one target content consumption feature label in at least one target content consumption feature dimension based on associated data corresponding to the recommended content; and
displaying the at least one target content consumption feature label in the recommended content.

2. The method according to claim 1, wherein determining the at least one target content consumption feature label in the at least one target content consumption feature dimension based on the associated data corresponding to the recommended content comprises:
determining feature information corresponding to the associated data; and
determining the at least one target content consumption feature label in the at least one target content consumption feature dimension based on the feature information.

3. The method according to claim 2, wherein the associated data comprises at least one piece of media content to be recommended that corresponds to the recommended content; and
determining the feature information corresponding to the associated data comprises:
acquiring first parameter information associated with the at least one piece of media content, wherein the first parameter information comprises basic information and historical interaction information corresponding to the at least one piece of media content; and
determining the feature information associated with the at least one piece of media content based on the first parameter information, wherein the feature information comprises category information, creator information, and content type information corresponding to the at least one piece of media content.

4. The method according to claim 2, wherein the associated data comprises recommendation data in the recommended content, wherein the recommendation data comprises a recommendation text and/or a recommendation image; and
determining the feature information corresponding to the associated data comprises:
identifying a text keyword in the recommendation text, and/or identifying an image feature corresponding to the recommendation image; and
determining the text keyword and/or the image content as the feature information.

5. The method according to claim 2, wherein the associated data comprises a target interactive topic associated with the at least one piece of recommended content; and
determining the feature information corresponding to the associated data comprises:
determining at least one keyword associated with the recommended content in the target interactive topic; and
determining the at least one keyword as the feature information.

6. The method according to claim 2, wherein determining the at least one target content consumption feature label in the at least one target content consumption feature dimension based on the feature information comprises:
determining, for each content consumption feature label, similarity information between the content consumption feature label and the feature information; and
determining at least one content consumption feature label with the similarity information satisfying a preset condition as the at least one target content consumption feature label.

7. The method according to claim 2, wherein determining the at least one target content consumption feature label in the at least one target content consumption feature dimension based on the feature information comprises:
determining, from a plurality of content consumption feature dimensions, a target content consumption feature dimension matching at least partial feature information based on the at least partial feature information; and
determining, from the at least one content consumption feature label corresponding to the target content consumption feature dimension, at least one target content consumption feature label matching remaining feature information based on the remaining feature information.

8. The method according to claim 1, wherein displaying the at least one piece of recommended content for recommending the media content comprises:
displaying at least one piece of interactive topic content in a preset interactive page;
in response to a trigger operation performed by a user for any piece of the interactive topic content, displaying a content display page associated with the interactive topic content; and
displaying the at least one piece of recommended content related to the interactive topic content in the content display page.

9. The method according to claim 1, wherein displaying the at least one piece of recommended content for recommending the media content comprises:
displaying at least one piece of interactive topic content historically published by a user in a preset information page;
in response to a trigger operation performed by a user for any piece of the interactive topic content, displaying a content display page associated with the interactive topic content; and
displaying the at least one piece of recommended content related to the interactive topic content in the content display page.

10. The method according to claim 1, wherein displaying the at least one piece of recommended content for recommending the media content comprises:
displaying a preset content recommendation list, wherein the content recommendation list comprises at least one recommendation topic;
in response to a trigger operation performed by a user for any recommendation topic, displaying a content display page associated with the recommendation topic; and
displaying the at least one piece of recommended content related to the recommendation topic in the content display page.

11. The method according to claim 1, wherein after displaying the at least one piece of recommended content for recommending the media content, the method further comprises:
acquiring, for each piece of recommended content, the historical consumption data of the publisher corresponding to the recommended content;
determining browsing data and interaction data of the publisher for the media content based on the historical consumption data, wherein the browsing data at least comprises a browsing duration corresponding to each piece of media content, and the interaction data comprises comment content and/or the recommended content published by the publisher for the media content; and
determining the at least one content consumption feature label associated with the publisher based on the browsing data and/or the interaction data.

12. The method according to claim 11, wherein determining the at least one content consumption feature label associated with the publisher based on the browsing data and/or the interaction data comprises:
acquiring associated consumption data of a user for the media content, wherein the user is a user who performs a browsing operation on the at least one piece of recommended content;
determining a related browsing behavior between the user and the publisher based on the associated consumption data and the browsing data and/or the interaction data; and
determining the at least one content consumption feature label associated with the publisher based on the related browsing behavior.

13. The method according to claim 11, wherein determining the at least one content consumption feature label associated with the publisher based on the browsing data and/or the interaction data comprises:
determining browsing feature information of the publisher for the media content based on the browsing data, wherein the browsing feature information comprises at least one media content category with a browsing duration of the publisher reaching a preset duration threshold and historical browsing age of the publisher; and
determining the at least one content consumption feature label associated with the publisher based on the browsing feature information.

14. The method according to claim 1, wherein the method further comprises:
displaying at least one piece of recommended content for recommending book media content, wherein the publisher of the recommended content is associated with at least one content consumption feature label related to a browsing behavior for the book media content;
determining at least one target content consumption feature label in at least one target content consumption feature dimension based on recommendation association information associated with each piece of recommended content, wherein the recommendation association information comprises at least one of the followings: at least one book to be recommended in the recommended content, recommendation data generated by the publisher based on the at least one book to be recommended, and an interactive topic associated with the at least one piece of recommended content; and
displaying the at least one target content consumption feature label in a display region associated with the recommended content, so that a user views the recommended content based on the at least one target content consumption feature label.

15. The method according to claim 1, wherein the method further comprises:
displaying at least one piece of recommended content for recommending video media content, wherein the publisher of the recommended content is associated with at least one content consumption feature label related to a browsing behavior for the video media content;
determining at least one target content consumption feature label in at least one target content consumption feature dimension based on recommendation association information associated with each piece of recommended content, wherein the recommendation association information comprises at least one of the followings: at least one video to be recommended in the recommended content, recommendation data generated by the publisher based on the at least one video to be recommended, and an interactive topic associated with the at least one piece of recommended content; and
displaying the at least one target content consumption feature label in a display region associated with the recommended content, so that a user views the recommended content based on the at least one target content consumption feature label.

16. A method for displaying content, comprising:
acquiring recommended content to be published, wherein the recommended content to be published comprises at least one piece of media content to be recommended and recommendation data generated based on the at least one piece of media content to be recommended;
determining at least one content consumption feature label associated with a user, wherein the content consumption feature label is generated based on historical consumption data of the user for the media content;
determining at least one target content consumption feature label in at least one target content consumption feature dimension based on the recommended content and a publishing scene associated with the recommended content; and
publishing the recommended content, wherein the at least one target content consumption feature label is carried in the recommended content.

17. An electronic device, comprising:
a processor; and
a memory, wherein the memory stores computer-executable instructions, and wherein the computer-executable instructions, when executed by the process, cause the processor to:
display at least one piece of recommended content for recommending media content, wherein a publisher of the recommended content is associated with at least one content consumption feature label, wherein the content consumption feature label is generated based on historical consumption data of the publisher for the media content, and wherein the content consumption feature label corresponds to different content consumption feature dimensions;
determine at least one target content consumption feature label in at least one target content consumption feature dimension based on associated data corresponding to the recommended content; and
display the at least one target content consumption feature label in the recommended content.

18. The electronic device according to claim 1, wherein the computer-executable instructions causing the processor to determine the at least one target content consumption feature label in the at least one target content consumption feature dimension based on the associated data corresponding to the recommended content comprises instructions causing the processor to:
determine feature information corresponding to the associated data; and
determine the at least one target content consumption feature label in the at least one target content consumption feature dimension based on the feature information.

19. The electronic device according to claim 17, wherein the computer-executable instructions causing the processor to display the at least one piece of recommended content for recommending the media content comprises instructions causing the processor to:
display at least one piece of interactive topic content in a preset interactive page;
in response to a trigger operation performed by a user for any piece of the interactive topic content, display a content display page associated with the interactive topic content; and
display the at least one piece of recommended content related to the interactive topic content in the content display page.

20. The electronic device according to claim 17, wherein the computer-executable instructions causing the processor to display the at least one piece of recommended content for recommending the media content comprises instructions causing the processor to:
display at least one piece of interactive topic content historically published by a user in a preset information page;
in response to a trigger operation performed by a user for any piece of the interactive topic content, display a content display page associated with the interactive topic content; and
display the at least one piece of recommended content related to the interactive topic content in the content display page.
